(19) United States
(12) Patent Application Publication
(10) Pub. No.: US 2007/0251774 A1
(43) Pub. Date: Nov. 1, 2007

(54) Actuating Device, Particularly For a Parking Brake

(76) Inventors: Norbert Deutloff, Thungersheim (DE); Ekkehard Kraft, Retzstadt (DE); Stephan Roos, Wertheim (DE); Armin Sauer, Arnstein (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/572,768

(22) PCT Filed: Jul. 18, 2005
(86) PCT No.: PCT/EP05/53455

§ 371 Date: Jan. 26, 2007

(30) Foreign Application Priority Data
Jul. 27, 2004 (EP) 04017782.6

(51) Int. Cl. F16D 65/38

(52) U.S. Cl. 188/156

(57) ABSTRACT

To provide a simple cable compensation in an actuating device (1), particularly an electromechanically actuated motor vehicle parking brake, a coupling device (20; 40) for canceling and restoring a frictional connection between the actuator (3) and brake cable pull (4)is provided. To this end, the coupling device (20; 40) has a coupling element (21; 41) which, when the brake cable pull (4) is released, can, in order to cancel the frictional connection, be deflected and transferred into a defined final position via a gate (26, 27, 28, 29, 30, 31, 32, 33, 34, 35; 44, 45, 46, 47, 48).

### CROSS-REFERENCE TO RELATED APPLICATIONS

This application is a U.S. national stage application of International Application No. PCT/EP2005/053455 filed Jul. 18, 2005, which designates the United States of America, and claims priority to European application number 04017782.6 filed Jul. 27, 2004, the contents of which are hereby incorporated by reference in their entirety.

### TECHNICAL FIELD

The invention relates to an actuating device, particularly an electromechanically actuated motor vehicle parking brake.

### BACKGROUND

During the operation of a parking brake it is necessary to adjust the brake cable length because of wear and tear in, for example, the brake shoes, or the setting properties, for example of the brake cable. For this reason, unnecessary cable travel should in essence be prevented when tightening the brake cable so that the brake cable can be tightened quickly and securely.

Mechanical adjusting devices are well-known from the prior art, said devices mostly being inserted in the flow of force of the brake cable pull by way of a “mechanical series connection”. The basic principle of such adjusting devices is based on the fact that two teeth mesh into each other and transfer the cable force. As soon as the teeth no longer mesh into each other, the flow of force is interrupted. In such cases the one tooth is then usually embodied as a toothed rack and the other tooth as the pawl. In such arrangements, depending on the wear and tear, the pawl then meshes into a specific tooth of the toothed rack.

In the case of electromechanically actuated parking brakes, for example a parking brake driven by an electromotive actuated brake actuator with a spindle drive, the adjustment is undertaken by measuring the two interdependent values, namely, the brake travel and the brake force, in conjunction with a corresponding controlling of the drive. The disadvantage of this method however is the fact that measuring the travel, measuring the force and controlling the drive require components that are relatively expensive and also prone to faults.

### SUMMARY

The object of the present invention is to provide an actuating device, in particular an electromechanically actuated motor vehicle parking brake, with simple cable compensation.

According to an embodiment, an actuating device may comprise an electromechanically actuated drive, an actuator which can be actuated by the drive, a brake cable pull which can be actuated by the actuator, and a coupling device for cancelling and restoring a frictional connection between the actuator and the brake cable pull, wherein the coupling device comprises a coupling element which, when the brake cable pull is released, can, in order to cancel the frictional connection, be deflected and transferred into a defined final position via a gate type gear.

### BRIEF DESCRIPTION OF THE DRAWINGS

The invention is described in greater detail below on the basis of schematic diagrams of exemplary embodiments, which are further explained with reference to drawings. These drawings are as follows:

FIG. 1 a perspective view of an actuating device with a partially cutaway housing,

FIG. 2 a first embodiment of an actuating device with a partially applied brake cable pull in a longitudinal section,

FIG. 3 a section from FIG. 2 with some components shown as transparent by means of a broken line,

FIG. 4 the actuating device in accordance with FIG. 2 with a released brake cable pull,

FIG. 5 a section from FIG. 4 with some components shown as transparent by means of a broken line,

FIG. 6 a second embodiment of an actuating device with a partially applied brake cable pull in a longitudinal section,

FIG. 7 a section from FIG. 6 with some components shown as transparent by means of a broken line,

FIG. 8 the actuating device in accordance with FIG. 6 with a released brake cable pull,

FIG. 9 a section from FIG. 8 with some components shown as transparent by means of a broken line,

FIG. 10 a third embodiment of an actuating device with a partially applied brake cable pull in a longitudinal section,

FIG. 11 a section from FIG. 10 with some components shown as transparent by means of a broken line,

FIG. 12 the actuating device in accordance with FIG. 10 with a released brake cable pull,

FIG. 13 a section from FIG. 12 with some components shown as transparent by means of a broken line,

FIG. 14 an actuating device with emergency actuation with a partially applied brake cable pull,

FIG. 15 the actuating device from FIG. 14 with a released brake cable pull.

### DETAILED DESCRIPTION

A fundamental concept of the invention is that provision must also be made, in the case of electromechanically actuated parking brakes, for a cable compensation, which is essentially based on a mechanical system. This does way with the costly signal detection processes of travel measurement and force measurement and of processing said signals.

According to an embodiment, provision has been made for the flow of force between the brake actuator and the brake cable pull to be split in the case of each releasing process. Because of this, the brake cable pull becomes free from forces in the released state. This means that it moves into a position which corresponds to the most recent brake cable pull characteristics in each case (such as for example lengthening or shortening of the brake cable). Because the coupling element is moved to a defined end position, an automatic restoration of the frictional connection in an optimum position is effected when the brake cable pull is retightened. In other words, an automatic cable adjustment takes place as a result, without measurement of the travel or such like being necessary.

According to an embodiment, the flow of force is split by using a coupling device, with the coupling device comprising a coupling element which, when the brake cable pull is released, can, in order to cancel the frictional connection, be deflected and transferred into a defined end position via a gate type gear.

According to an embodiment, the coupling device can be actuated by the same actuator that actuates the brake cable pull. Because of this, it is in particular possible for the actuating device to be designed in a very compact manner. According to an embodiment, alternatively, it is also possible to make provision for a separate actuator for actuating the coupling device. In this case, it is also possible for the coupling device to be actuated independently from the actuation of the brake cable pull.

According to an embodiment, it can be especially advantageous for the actuation of the coupling device to be controlled. In particular, according to an embodiment, this allows a decision to be made from case to case as to whether or not the coupling element is to be moved to a defined final position and a cable compensation is thus to take place or, on the other hand, whether or not only the frictional flow between the actuator and the brake cable pull should be split without it being necessary to implement a cable compensation. According to an embodiment, a control unit can be preferably provided for this purpose. If the actuation of a coupling device cannot be controlled, according to an embodiment, the cable compensation is preferably performed for each releasing process.

According to an embodiment, the coupling element can be deflected via a gate type gear. In an embodiment, the coupling element at the same time meshes into a curve guide, which describes a track curve deviating from the axial direction of movement of the actuator. According to an embodiment, the curve guide can be advantageously already provided in part of the housing of the actuating device. Movement of the coupling element in an axial direction deflects the coupling element and thus cancels the frictional connection between actuator and brake cable pull.

According to an embodiment, the coupling element can be deflected via a gate type gear by means of an actuation element. According to an embodiment, this actuation element is preferably embodied as a push button fitted to the coupling device, which is moved in the event of an axial movement of the coupling device and actuates a shift lever fitted to the coupling element. According to an embodiment, the movement on deflection of the coupling element is determined here by the shape of the shift lever. According to an embodiment, the coupling element is preferably deflected by the actuation element, on reaching a specific axial position of the coupling device, resting on a limit stop in a selected position and the shift lever being actuated by an additional axial movement of the coupling device in the direction of the limit stop. According to an embodiment, the limit stop is preferably embodied as part of an existing housing of the actuating device.

According to a further embodiment, the actuation element and the coupling element can be combined in a common component. The cost of construction is reduced further by this.

Finally, according to a further embodiment, provision has been made for a spring element, which in the case of a canceled frictional connection, exerts a force on one part of the coupling device, and for this reason guarantees a defined cable pre-tensioning force on restoration of the frictional connection between the actuator and the brake cable pull.

According to an embodiment, the position of the limit stop can be preferably be varied, so that the implementation of a cable adjustment can be set depending on application parameters.

The invention is explained with reference to an electromechanically actuated motor vehicle parking brake.

Elements with the same function are labeled in all the figures by the same reference symbols.

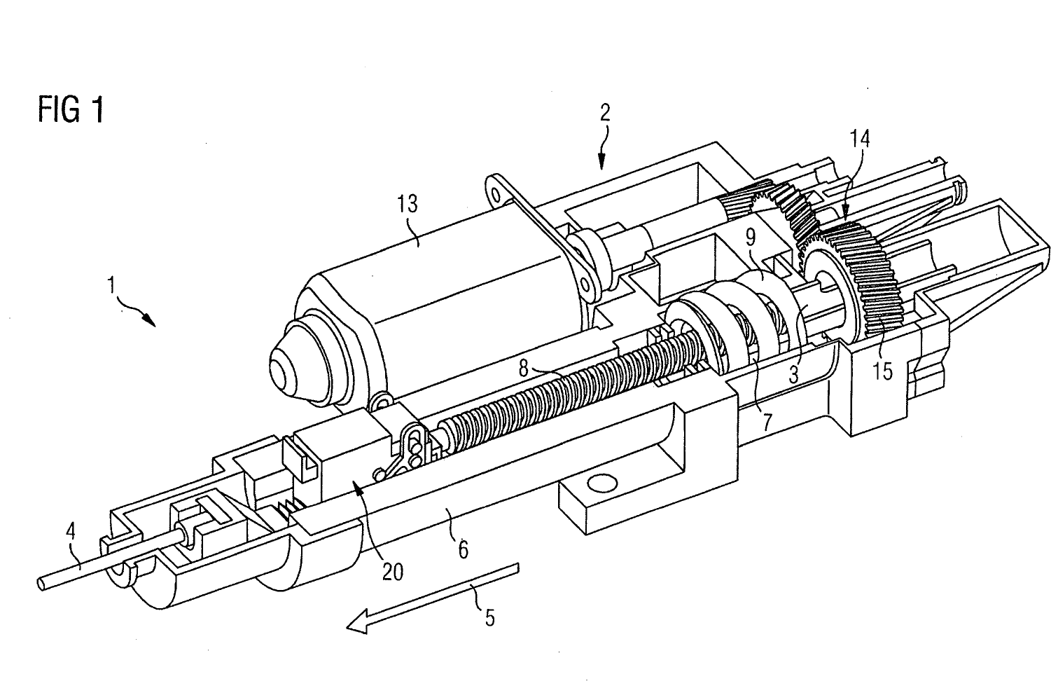

As shown in FIG. 1, the actuating device 1 essentially consists of an electromechanical drive 2; an actuator 3 which can be actuated by the drive 2 as well as a brake cable pull 4 that can be actuated by an actuator 3.

In this case the actuator 3, which can be displaced in an axial direction 5, is accommodated in a housing 6 in the form of a telescopic device. The actuator 3 consists of a sleeve shaft 7 and a spindle-type shaft 8 that can be actuated with it in an axial rotary feed connection operating the brake cable pull 4.

As feed support of the sleeve shaft 7, provision has been made for an elastic element in the form of a coil spring 9 arranged concentrically around the sleeve shaft 7 or the spindle-type shaft 8, which in the form of a compression spring with its one end forms a close fit via a fixed axial thrust bearing 10 with a shoulder 11 of the housing 6 and with its other axial end with a surrounding collar 12 of the sleeve shaft 7.

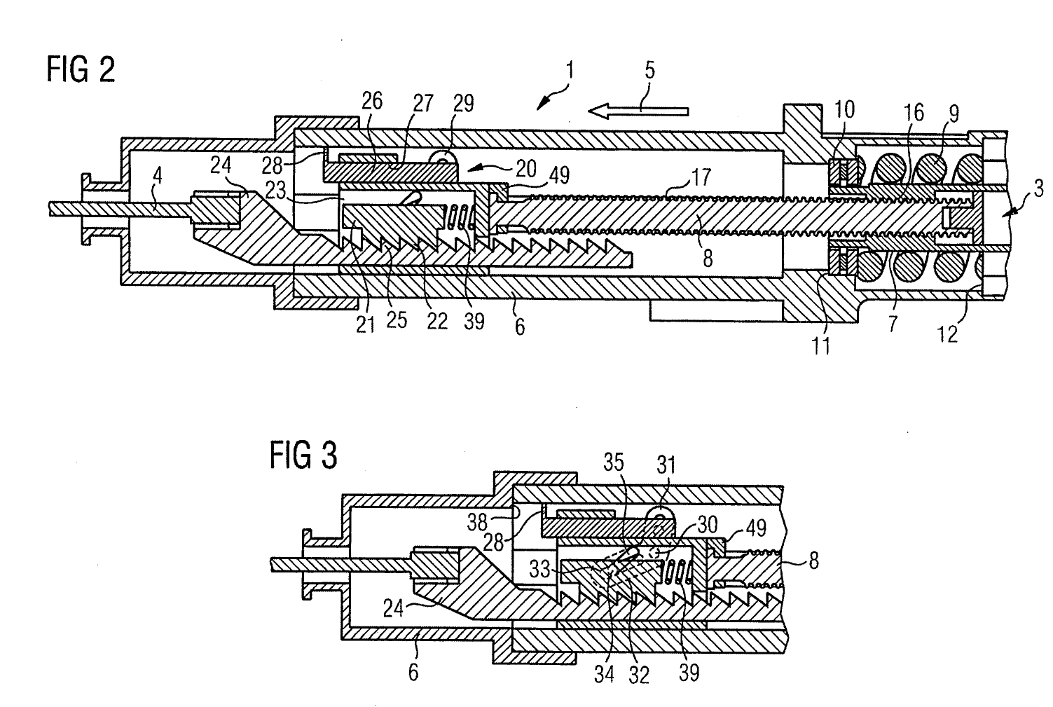

FIGS. 2 and 3 show a first embodiment with an applied brake cable pull 4 (brake-on position). When the actuator 3 is actuated in the sense of moving the brake cable pull 4 to the right, i.e. in the sense of applying the parking brake, the coil spring 9 is compressed by being pressed against the axial bearing 10.

When this is done a torque is transferred from an electric motor 13 of the actuating device 1 via a gear unit 14 to a drive gear 15 which can be displaced in an axial manner and which is in a fixed driving connection with the sleeve shaft 7 in the form of a toothed gear. The sleeve shaft 7 set in rotation by the drive gear 15 has an internal thread 16. Via this internal thread 16, an axial feed motion of the spindle-type shaft depending on the direction of rotation of the drive 8 is achieved in a positive or a negative axial direction 5 via the meshing external thread 17 of the spindle-type shaft.

The actuator 3 and the brake cable pull 4 are connected with each other by a coupling device 20. The coupling device 20 consists of a coupling element 21 and a toothed rack 24 embodied as a ratchet. The coupling element 21 consists of a plurality of pawls embodied as teeth 22. The coupling element 21 is arranged in a housing of the coupling device 23, to which the spindle-type shaft 8 of the actuator 3 is fastened on the front side, at the front end in each case. A toothed rack 24 extending into the housing 6 of the parking brake 1 in an axial direction 5 is fastened in such a way to the brake cable pull 4 that in the position shown with an applied brake cable pull 4, the coupling element 21, with its teeth 22 meshes into the teeth 25 of the toothed rack 24 resulting in a frictional connection between the actuator 3 and the brake cable pull 4 for transferring the cable force.

An actuating mechanism 26 is stored in the housing of the coupling device 23 in an axial guide 27. The actuating mechanism 26 has an actuation limit stop 28 at its end pointing in the direction of the brake cable pull 4. At its other end, the actuating mechanism 26 is connected to a shift lever 29, which is connected to the housing of the coupling device 23 at a center of rotation 30 so that it can rotate. The shift lever 29 in this case has two shanks 31, 32, which are arranged in an obtuse angle to each other. Therefore the center of rotation 30 is arranged here at the connecting point of the two shanks. The one shank 31 of the shift lever 29 is connected to the actuating mechanism 26 so that it can move, while the other shank 32 of the shift lever 29 has a gate 33, into which a pin-shaped steering element 34 that is fitted to the coupling element 21 engages. This steering element 34 at the same time meshes into a gate 35 of the housing of the coupling device 23 running at an incline to the axial direction 5.

In order to release the brake cable pull 4, the sleeve shaft 7 must be turned by the electric motor 13, so that the spindle-type shaft 8 moves to the left. As the releasing travel increases, the load acting on the brake cable pull 4 decreases. At the same time, the coil spring 9 is released. By relieving the load, the sleeve shaft 7 including the drive gear 15 is pushed to the right by means of the spring tension of the coil spring 9.

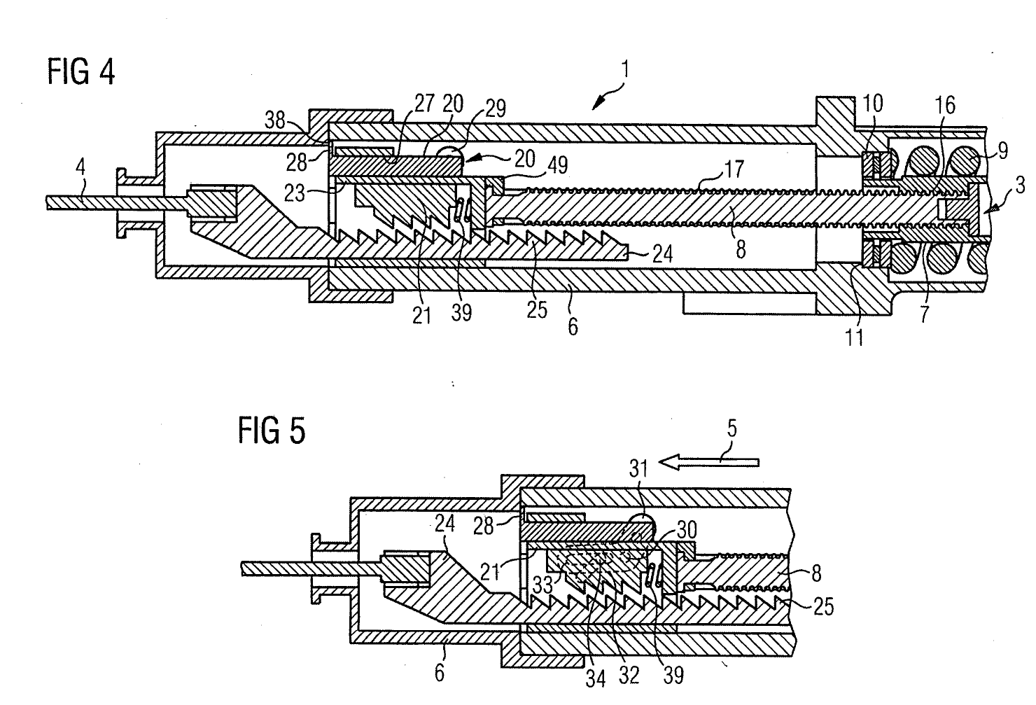

When the actuator 3 moves to the releasing position, the actuating mechanism 26 with its actuation limit stop 28 comes up against a final limit stop 38 for which provision has been made at the housing 6 of the actuating device 1. If the movement of the coupling device 20 continues, the actuating mechanism 26 in its axial guide 27 in the housing of the coupling device 23 proceeds in such a way that the shift lever 29 fastened to the actuating mechanism 26 is deflected. In this case, the shank 31 of the shift lever 29 connected to the actuating mechanism 26 moves in the direction of the spindle-type shaft 8. By the rotation of the shift lever 29 around its center of rotation 30 brought about as a result of this, the steering element 34 is displaced by means of a gate 33 of the second shank 32 in the gate 35 of the housing of the coupling device 23. By way of this, the coupling element 21 connected to the steering element 34 is moved out of the frictional connection plane whereby the frictional connection between the actuator 3 and the brake cable pull 4 is released. A releasing position of this type is shown in FIGS. 4 and 5.

The coupling device 20 moves to a defined final position, in which the maximum distance of the actuating mechanism 26 in the axial guide 27 of the housing of the coupling device 23 has been covered or any additional travel of the coupling device 20 in the direction of the final limit stop 38 is no longer possible.

In the releasing position, the brake cable pull 4 is load-free. If required, there is an automatic change in the position of the brake cable pull 4 in order to compensate for the changes in length. This produces an optimum stroke as well as a short activation period and thereby optimizes the next tightening process of the parking brake 1.

In order to restore the frictional connection between actuator 3 and brake cable pull 4, an actuation of the actuator 3 in the sense of a movement of the spindle-type shaft 8 to the right is necessary. The coupling device 20 is carried along by the spindle-type shaft 8, by means of which the coupling element 21 is again guided back to the frictional connection plane. In addition, provision has been made for a spring element 39 in this case, which is arranged between the housing of the coupling device 23 and the coupling element 21 and is compressed during the splitting of the frictional connection. On tightening or applying the actuating device 1, the spring element 39 then pushes the coupling element 21 along the gate 35 into the toothed rack 24.

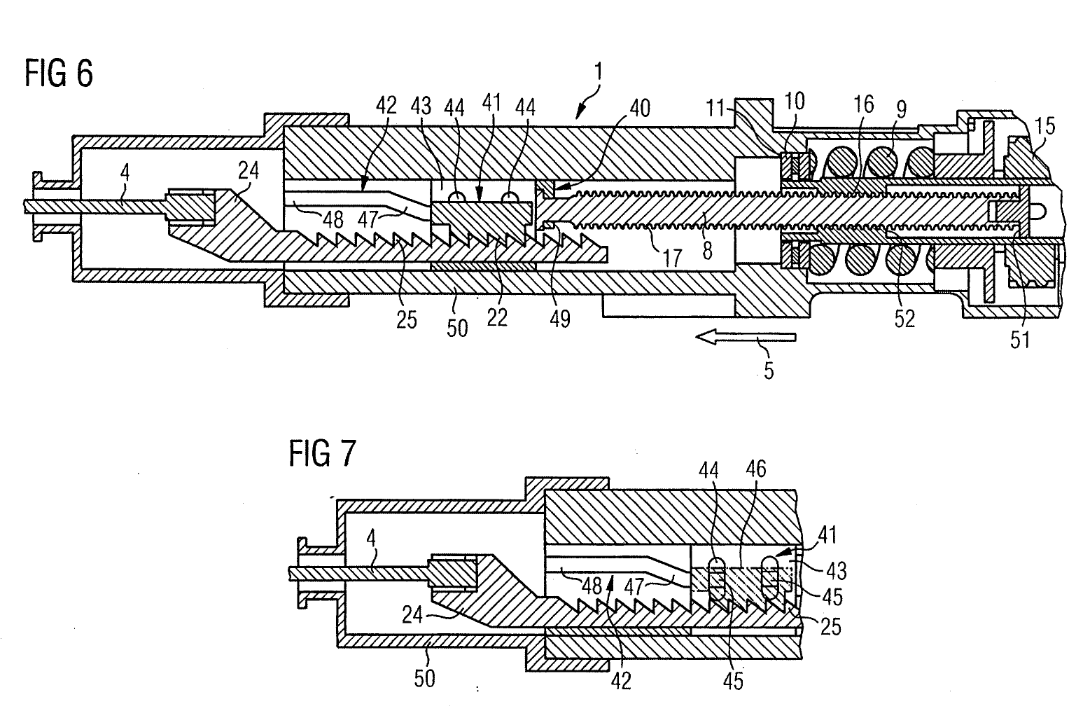

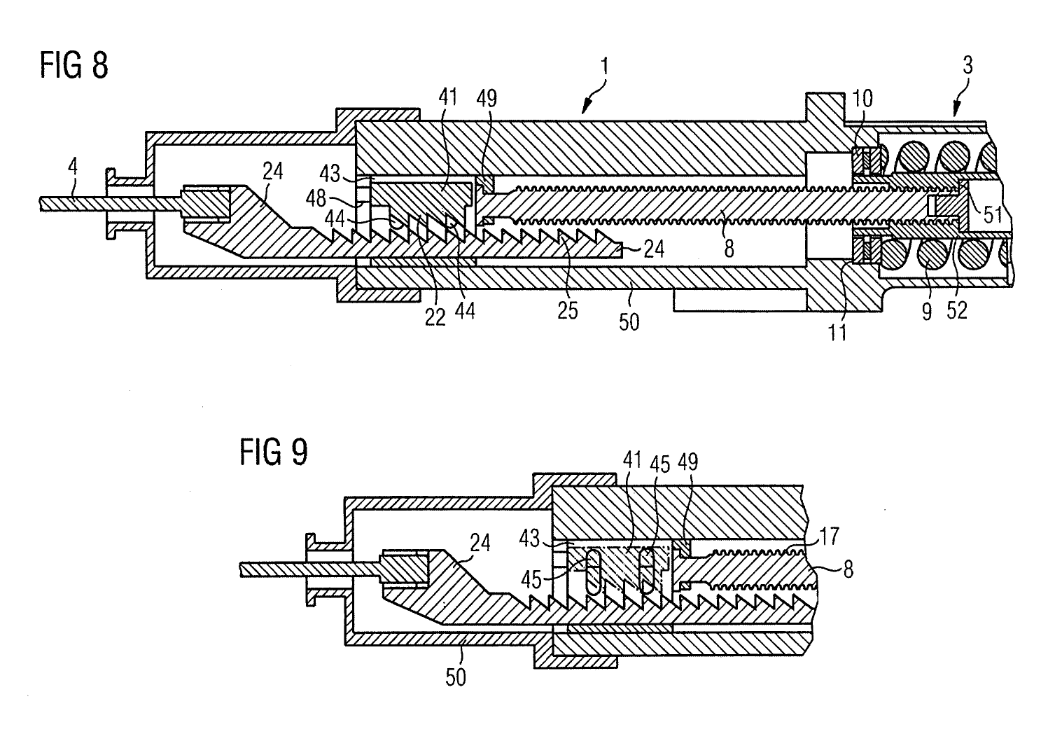

In the embodiment shown in FIGS. 6-9 of the parking brake 1, a coupling device 40 which does not have an actuating mechanism is used. The spring element at the coupling element is also missing here. The coupling element 41 is deflected by guiding it in a curve guide 42 provided in the housing 50 of the actuating device 1. To this end, lateral housing surfaces 43 have been fitted to the coupling element 41, in which provision has been made for two gates 44 running at right angles to the axial direction 5 in each case. In these gates 44, rigidly connected pin-shaped steering elements 45 mesh into the coupling element 41. These steering elements 45, in addition permanently mesh into the curve guide 42. In this case, the curve guide 42 introduced into a housing 50, on a first part 46, runs parallel to the axial direction 5 in such a way that the coupling element 41 is located in the frictional connection plane. A second part 47 is connected to this first part 46 in which the curve guide 42 runs at an incline to the axial direction 5. The track guide 42 ends in a third part 48, which again runs parallel to the axial direction 5, but runs offset to the first part 46.

The spindle-type shaft 8 is again connected to a part of the housing 49 of the coupling device 40. When the actuator 3 is operated, in the sense of releasing the parking brake 1, the spindle-type shaft 8 is moved and thereby also moves the coupling device 40 to the left. When this occurs the steering elements 45 meshing into the curve guide 42 and connected to the coupling element 41 change their position in the gates 44 in such a way that the coupling element 41 is taken out of the frictional connection plane.

In the releasing position the brake cable pull 4 is again load-free and can freely select its position so that a retightening of the parking brake 1 is carried out with a compensated brake cable pull 4.

At the end of the spindle-type shaft 8, which faces the coupling element 41, provision has been made for a limit stop 51, which serves to determine a final position of the coupling device 40. In the case of a fully released brake cable pull 4, the limit stop 51 comes up against an opposing limit stop 52 which is provided at the sleeve shaft 7. The spindle-type shaft 8 can then no longer be extended in the direction of the brake cable pull 4. The limit stop 51 is preferably provided with a screw thread and it is possible to screw it into the thread opening of the spindle-type shaft 8 so that the final position of the spindle-type shaft 8 can be adjusted within the framework of the length of the thread. As an alternative, the limit stop 51 can also have a smooth cylinder foot or base instead of a screw thread for making a permanent connection by pushing it into an opening of the spindle-type shaft 8.

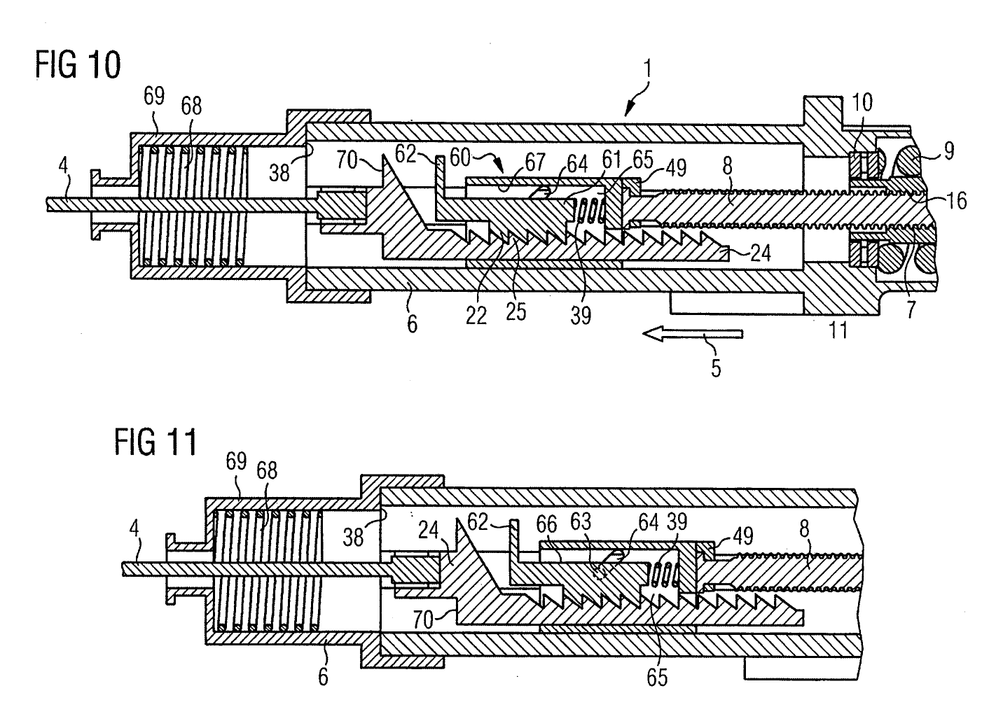

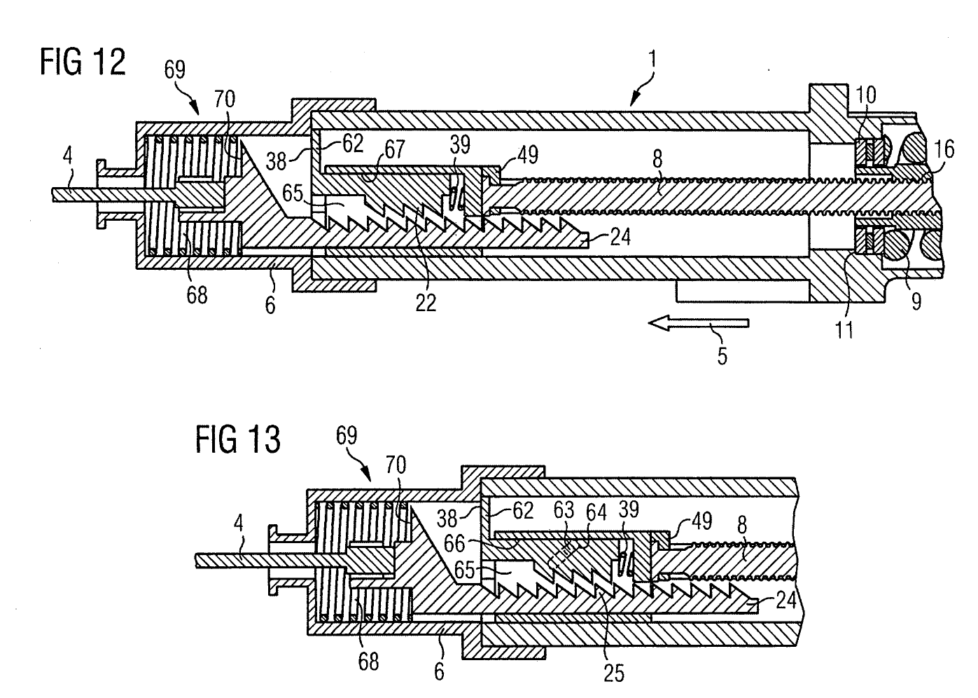

In the embodiment shown in FIGS. 10-13 of the actuating device 1, a coupling device 60 with a coupling element 61 is used in which an actuating mechanism 62 is fitted directly to the coupling element 61. A shift lever is not required in this case. On releasing the parking brake, the coupling element 61 travels to the left in the direction of the final limit stop 38. In this embodiment, the final limit stop 38 is embodied as a projection or the like for which provision has been made on the side of the housing 6.

If the actuating mechanism 62 comes up against the final limit stop 38, with any further movement of the spindle-type shaft 8, the coupling element 61 will be moved out of the frictional connection plane. In its final position, the coupling element 61 rests with its upper side 66 on a face of the limit stop 67 of the housing of the coupling device 65. To hinge the coupling element 61 away from the frictional connection plane, provision has been made for a pin-shaped guide element 63 to be fitted to the coupling element 61, which meshes into a gate 64 of the housing of the coupling device 65 running at an angle to the axial direction 5. In the case of the spindle-type shaft 8 connected to a part of the housing 49 of the coupling device 60 traveling in the direction of the final limit stop 38, a spring element 39 arranged between the housing of the coupling device 65 and the coupling element 61 is compressed. On engaging the parking brake, the spring element 39 then again pushes the coupling element 61 along the gate 64 into the toothed rack 24.

An additional special feature of the embodiment shown in FIGS. 10-13 takes the form of a spring element exerting a force on the toothed rack 24. The spring element is embodied in the form of a compression spring 68 and serves to guarantee a defined cable pretensioning force. In the engaged or partially engaged state, the compression spring 68 lies free in a front section 69 of the housing 6 facing the brake cable pull 4. If the brake cable pull 4 is released, a round limit stop 70 provided at the end of the toothed rack 24 meets the compression spring 68 and, in this way, strikes the compression spring 68 with a force acting on the brake cable pull 4. In this way, by suitably selecting the compression spring 68, it is possible to provide a defined and selected positioning of the toothed rack 24 at that point in time when the frictional connection is restored. In other words, the cable force acting on the brake cable pull 4 is determined by the spring tension of the compression spring 68. Because of this, an automatic adjustment of the cable length to the brake cable pull 4 can be implemented in a simple way. On tightening the brake cable pull 4, unnecessary cable travel is prevented in this case. Therefore, the brake cable pull 4 can be tightened quickly and securely.

This cable compensation mechanism can be used in all the embodiments described.

In all the embodiments, a control unit serves to actuate the actuator 3 arranged in the housing 6, 50, but it is not shown in greater detail and it also serves to actuate the coupling device 20, 40.

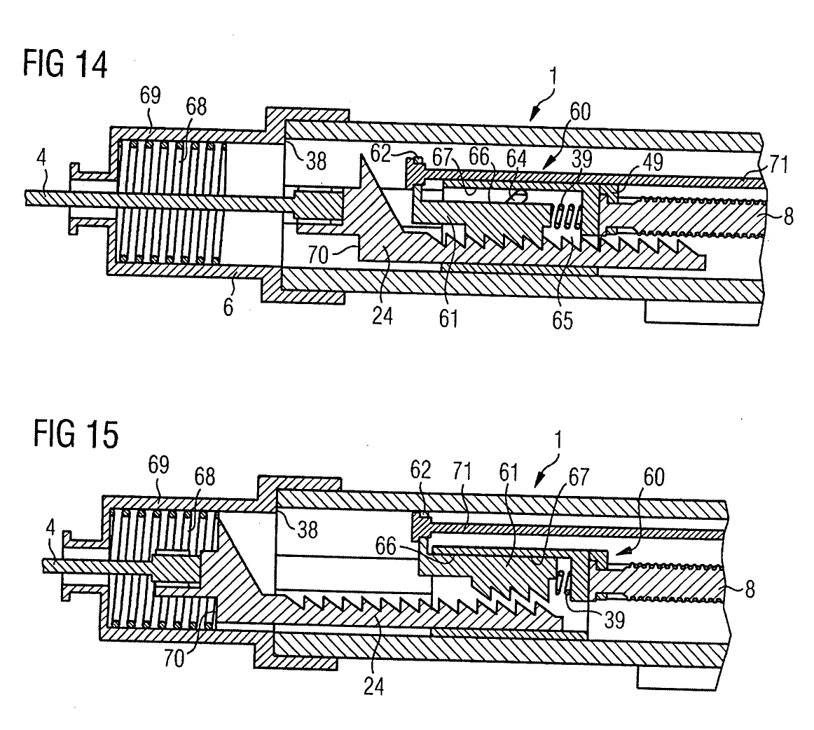

Finally, FIGS. 14 and 15 show an additional embodiment in which provision has been made for an emergency actuation of the parking brake in the sense of releasing the brake, for example, in the case of a non-functioning actuator 3. To this end, an additional cable pull 71 or the like is fitted to the actuating mechanism 62 of the coupling element 61, which runs outside the housing of the coupling device 65 and inside the housing 6 to an external actuation element for example an actuating pushbutton which does not depend on the actuator 3. By actuating the button, with a stationary spindle-type shaft 7, the coupling element 61 moves through the gate 64 against the pressure of the spring element 39 out of the frictional connection plane, preferably through to a final position, in which the coupling element 61 rests with its upper side 66 on a face of the limit stop 67 of the housing of the coupling device 65. An emergency actuation of this type can be applied, amongst others, in the embodiments shown in FIGS. 2 to 5 as well as in the embodiments shown in FIGS. 10 to 13.

What is claimed is:

1. An actuating device, comprising:
with an electromechanically actuated drive,
an actuator which can be actuated by the drive,
a brake cable pull which can be actuated by the actuator, and
a coupling device for cancelling and restoring a frictional connection between the actuator and the brake cable pull, wherein the coupling device comprises a coupling element which, when the brake cable pull is released, can, in order to cancel the frictional connection, be deflected and transferred into a defined final position via a gate type gear.

2. The actuating device according to claim 1, wherein the coupling device can be actuated by the brake actuator.

3. The actuating device according to claim 1, comprising a control unit for controlling the actuation of the coupling device.

4. The actuating device according to claim 1, providing an interaction of the gate type gear with a curve guide for the automatic deflection of the coupling element when the actuator is moved.

5. The actuating device according to claim 1, comprising an actuation element for the deflection of the coupling element when the actuator is moved.

6. The actuating device according to claim 5, comprising a limit stop for supporting the actuating element.

7. The actuating device according to claim 6, wherein the position of the limit stop can be adjusted.

8. The actuating device according to claim 5, wherein the actuating element and the coupling element are combined in a common component.

9. The actuating device according to claim 1, comprising a spring element which in the case of a cancelled frictional connection, exerts a force on one part of the coupling device and for this reason guarantees a defined cable pre-tensioning force when the frictional connection between the actuator and the brake cable pull is restored.

10. An actuating device, comprising:
an actuator actuated by an electromechanically actuated drive,
a brake cable pull actuated by the actuator, and
a coupling device comprising a coupling element which, when the brake cable pull is released, is deflected and transferred into a defined final position via a gate type gear.

11. The actuating device according to claim 10, wherein the coupling device is actuated by the brake actuator.

12. The actuating device according to claim 10, comprising a control unit for controlling the actuation of the coupling device.

13. The actuating device according to claim 10, providing an interaction of the gate type gear with a curve guide for the automatic deflection of the coupling element when the actuator is moved.

14. The actuating device according to claim 10, comprising an actuation element for the deflection of the coupling element when the actuator is moved.

15. The actuating device according to claim 14, comprising a limit stop for supporting the actuating element.

16. The actuating device according to claim 15, wherein the position of the limit stop can be adjusted.

17. The actuating device according to claim 14, wherein the actuating element and the coupling element are combined in a common component.

18. The actuating device according to claim 10, comprising a spring element which in the case of a cancelled frictional connection, exerts a force on one part of the coupling device, and guarantees a defined cable pre-tensioning force when the frictional connection between the actuator and the brake cable pull is restored.

19. An actuating device, comprising:
an actuator actuated by an electromechanically actuated drive,
a brake cable pull actuated by the actuator,
a coupling device actuated by the brake actuator comprising a coupling element which, when the brake cable pull is released, is deflected and transferred into a defined final position via a gate type gear,
a control unit for controlling the actuation of the coupling device, and
providing an interaction of the gate type gear with a curve guide for the automatic deflection of the coupling element when the actuator is moved.
